(19) United States
(12) Patent Application Publication
(10) Pub. No.: US 2017/0342763 A1
(43) Pub. Date: Nov. 30, 2017

(54) SAFE

(71) Applicant: ENNOMECH PRECISION CO., LTD., New Taipei (TW)

(72) Inventors: TUNG-MING YEH, New Taipei (TW); CHEN-LU FAN, New Taipei (TW); CHIH-KUN SHIH, Santa Clara, CA (US)

(21) Appl. No.: 15/227,209

(22) Filed: Aug. 3, 2016

(30) Foreign Application Priority Data
May 24, 2016 (CN) 201610348914.6

(51) Int. Cl. E05G 1/024; E05G 1/026

(52) U.S. Cl. CPC E05G 1/024; E05G 1/026; E05Y 2800/298; E05Y 2800/67; E05Y 2800/45

(57) ABSTRACT

A secure container includes a housing and a hinged door, the housing including an inner shell, an external shell, and a plurality of fastening brackets. The external shell surrounds the inner shell. The fastening brackets are inserted and fixed between the receiving space defined between the inner shell and the external shell. Each fastening bracket defines a plurality of first through holes through which a filler can be introduced, the fastening brackets lending strength and a particular placement to the filler.

### FIELD

The subject matter herein generally relates to secure containers, such as safes.

### BACKGROUND

Secure containers, such as safes, may include, for example, an inner steel plate and an external steel plate. Concrete can fill the space between the inner steel plate and the external plate. The distance between the inner steel plate and the external plate can be made larger to allow the concrete to be thicker, but that may unreasonably increase the weight of the safe.

### BRIEF DESCRIPTION OF THE DRAWINGS

Implementations of the present technology will now be described, by way of example only, with reference to the attached figures.

FIG. 1 is an isometric view of a secure container such as a safe.

FIG. 2 is an exploded isometric view of the safe of FIG. 1.

FIG. 3 is an isometric view of a fastening bracket of the safe of FIG. 2.

FIG. 4 is a sectioned isometric view of the safe of FIG. 1.

FIG. 5 is a cross-sectional view of the safe of FIG. 1 taken along the line V-V.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

A definition that applies throughout this disclosure will now be presented.

The term “comprising” means “including, but not necessarily limited to”; it specifically indicates open-ended inclusion or membership in a so-described combination, group, series, and the like.

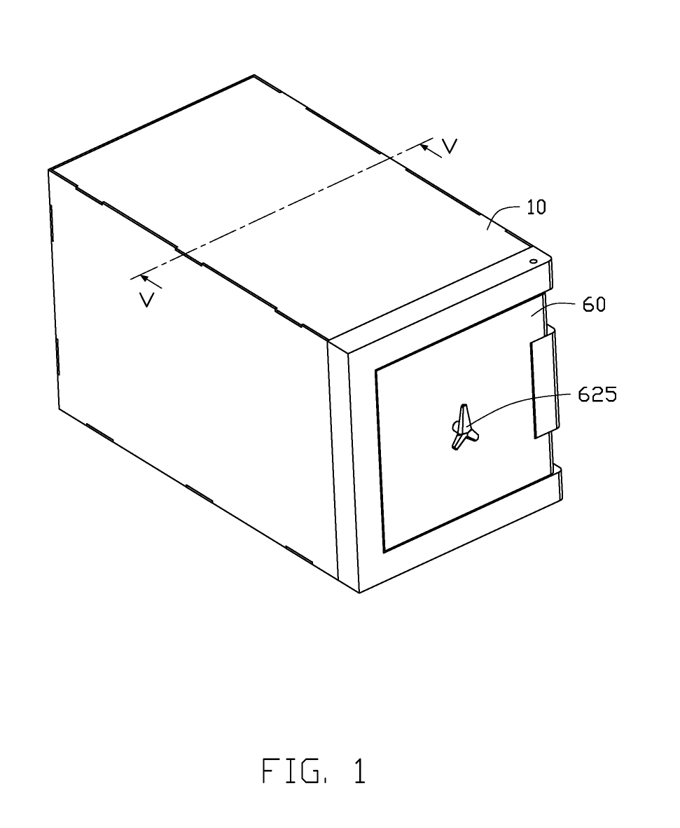

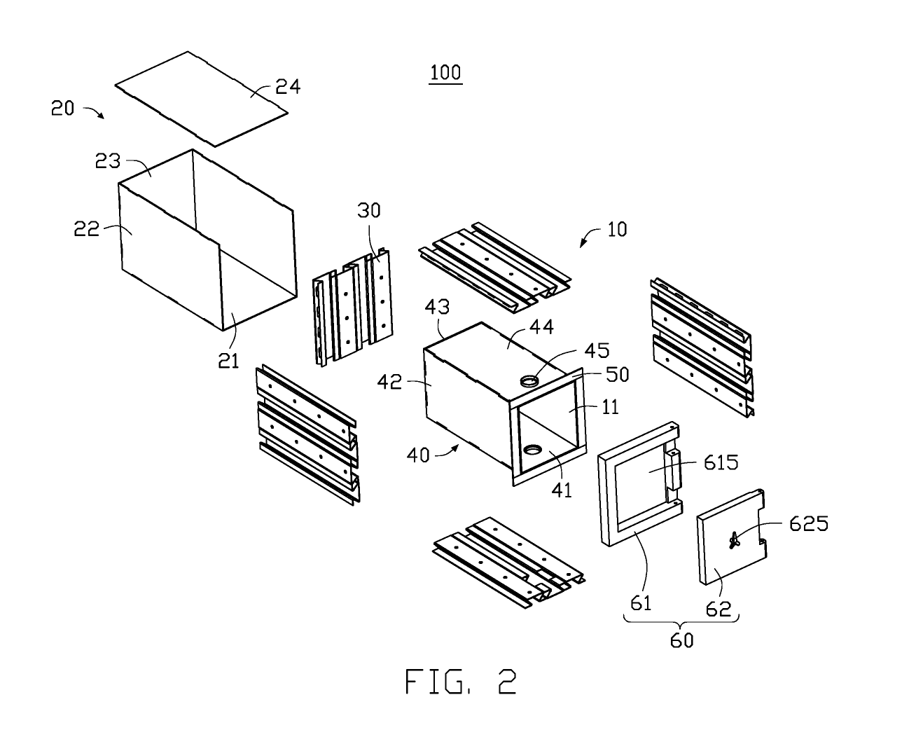

FIGS. 1 to 2 illustrate a secure container (safe) 100. The safe 100 includes a housing 10 and a door 60 hinged to the housing 10.

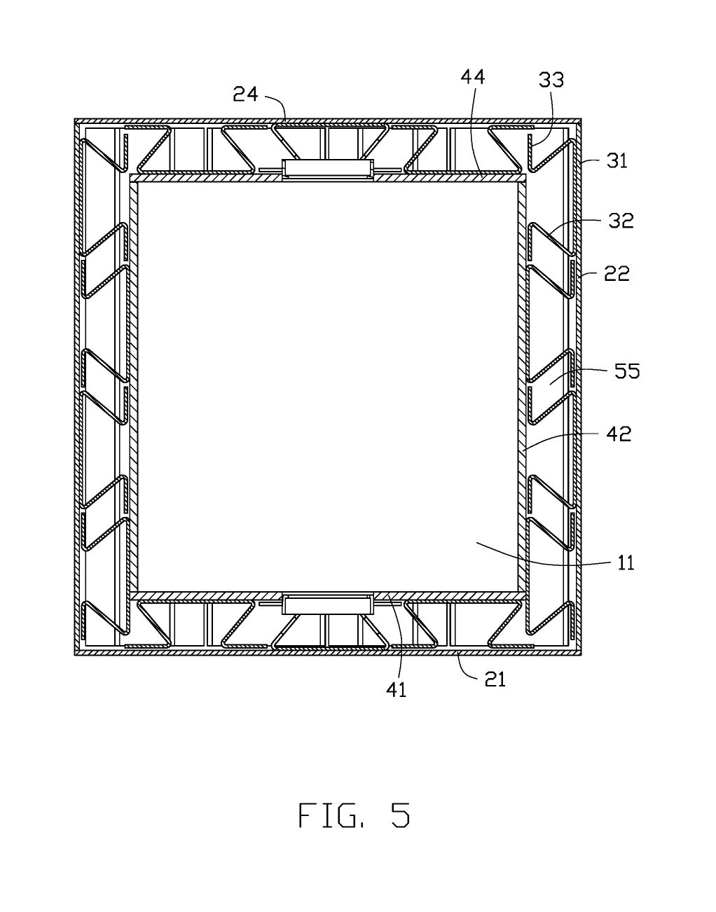

An exemplary housing 10 defines an accommodation space 11 for accommodating objects. The housing 10 includes an external shell 20, a number of fastening brackets 30, an inner shell 40, and blocking plates 50. The external shell 20 surrounds the inner shell 40. Also referring to FIG. 5, the inner shell 40 and the external shell 20 define a receiving space 55, therebetween. The fastening brackets 30 are received in the receiving space 55. The blocking plate 50 seals the receiving space 55. The receiving space 55 is configured to be filled with a filler, such as concrete. The external shell 20 includes a first bottom plate 21, two first side plates 22, a first rear plate 23 and a first top plate 24. The two first side plates 22 are perpendicularly connected to two opposite edges of the first bottom plate 21. The first rear plate 23 is perpendicularly connected to an end of the first bottom plate 21 and is connected between the two first side plates 22. The first top plate 24 is parallel to and positioned above the first bottom plate 21. The first bottom plate 21, the first side plate 22, the first rear plate 23, and the first top plate 24 are connected together by welding or other secure means.

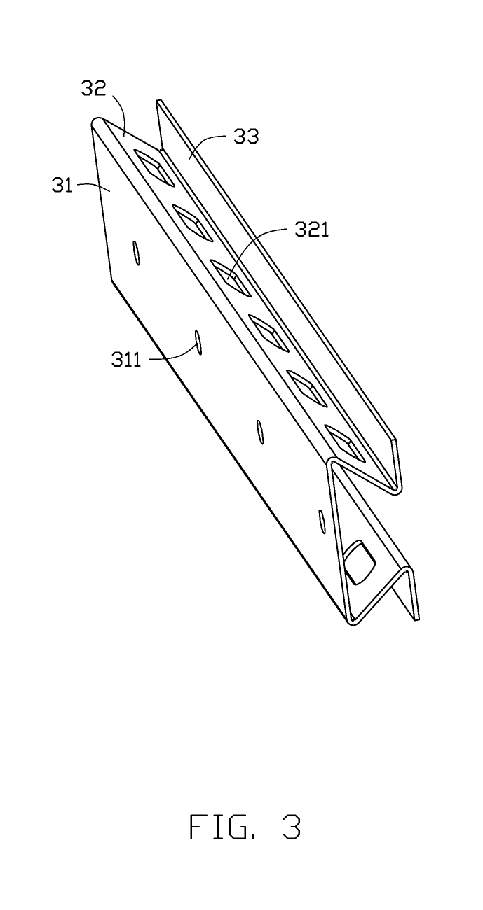

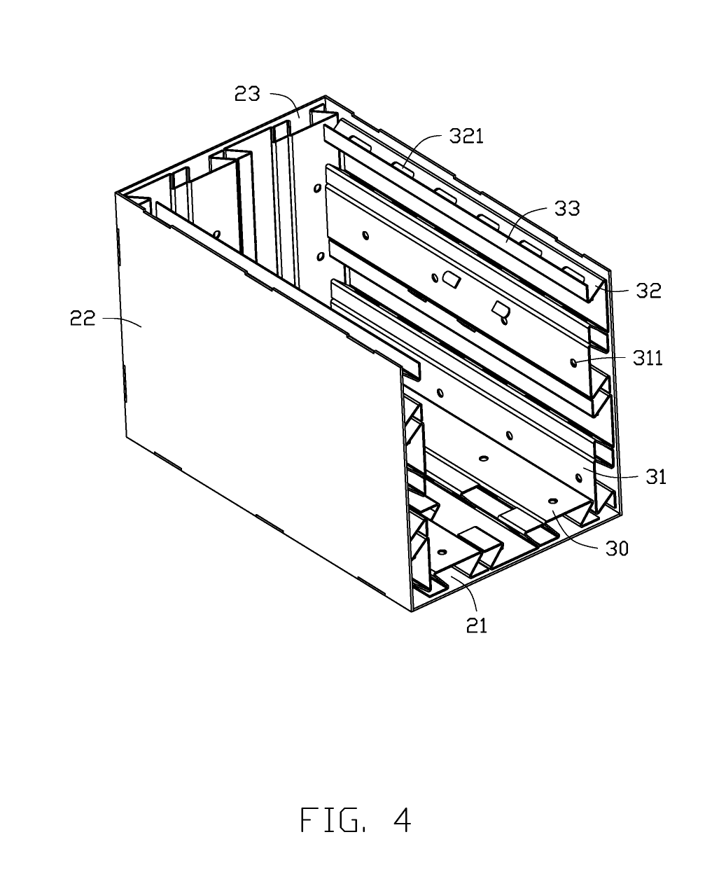

FIGS. 4-5 illustrate the fastening bracket 30 received in the receiving space 55 and being fixed to the external shell 40. The fastening bracket 30 may be made of steel. The fastening bracket 30 is fixed to the external shell 40 by welding. FIG. 3 illustrates that the fastening bracket 30 includes a base plate 31, two connecting plates 32, and two fixing plates 33. The two connecting plates 32 obliquely extend from two opposite sides of the base plate 31 and extend towards each other. A angle between the connecting plate 32 and the base plate 31 is acute, being between about 20° and about 85°. The two fixing plates 33 extend from two edges of the two connecting plates 32 away from the base plate 31 and apart from each other in a co-planar fashion. The two fixing plates 33 are parallel to the base plate 31. An edge of the fixing plate 33 away from the connecting plate 32 extends beyond the base plate 31. The base plate 30 and the fixing plate 33 are in an alternating fashion fixed either to the external shell 20 or to the inner shell 40.

The connecting plate 32 defines a number of first through holes 321. The first through hole 321 enables the filler to easily fill the receiving space 55. The fixing plate 33 can be connected to the inner shell 40 by welding. The base plate 31 defines a number of second through holes 311. The second through holes 311 are welding points. The base plate 31 can be welded to the external shell 20 through the second through holes 311.

FIGS. 2 and 5 illustrate that the inner shell 40 includes a second bottom plate 41, two second side plates 42, a second rear plate 43, and a second top plate 44. The two second side plates 42 are perpendicularly connected to two opposite edges of the second bottom plate 41. The second rear plate 43 is perpendicularly connected to an end edge of the second bottom plate 41 and is connected between the two second side plates 42. The second top plate 44 is parallel to and positioned above the second bottom plate 41. The second bottom plate 41, the second side plate 42, the second rear plate 43, and the second top plate 44 are connected together by welding. The second bottom plate 41, the second side plate 42, the second rear plate 43, and the second top plate 44 correspond on a to the first bottom plate 21, the first side plate 22, the first rear plate 23, and the first top plate 24, respectively.

The fastening brackets 30 are fixed between the external shell 20 and the inner shell 40. The base plate 30 and the fixing plate 33 are fixed in an alternating fashion to the external shell 20 and the inner shell 40. The second bottom plate 41 and the second top plate 44 define two pouring holes 45. The filler passes through the pouring holes 45 to fill the receiving space 55. The use of the fastening brackets 30 to allow for less filler material to need to be used and allow for the weight of the secure container to be reduced.

The door 60 includes a frame 61 and a door panel 62 rotationally attached to the frame 61. The frame 61 is fixed to the blocking plate 50. The frame 61 defines an opening 615 which defines the internal volume of the safe 100. The frame 61 can be fixed to the blocking plate 50 by welding. A handle 625 protrudes from an external side of the door panel 62 for closing or opening the door panel 62. The door may include a lock, not shown.

The embodiments shown and described above are only examples. Even though numerous descriptions and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A safe comprising:
a housing comprising:
an inner shell;
an external shell surrounding the inner shell, a receiving space is defined between the inner shell and the external shell; and
a plurality of fastening brackets fixed between the inner shell and the external shell, the fastening bracket defines a plurality of first through holes, the first through hole allow fillers to fill the receiving space; and
a door hinged to the housing.

2. The safe as claimed in claim 1, wherein the fastening bracket comprises a base plate, the base plate defines a plurality of second through holes, the second through holes are welding points, the base plate is welded to the external shell through the second through holes.

3. The safe as claimed in claim 2, wherein the fastening bracket further comprises two connecting plates, the two connecting plates obliquely extend from two opposite edges of the base plate and extend towards each other, the first through hole are defined on the connecting plate.

4. The safe as claimed in claim 3, wherein an angle between the connecting plate and the base plate is acute.

5. The safe as claimed in claim 4, wherein the angle is being between about 20° to about 85°.

6. The safe as claimed in claim 3, wherein the fastening bracket further comprises two fixing plates, the two fixing plates extend from two edges of the two connecting plates away from the base plate and apart from each other in a co-planar fashion.

7. The safe as claimed in claim 6, wherein the two fixing plates are parallel to the base plate.

8. The safe as claimed in claim 7, wherein an edge of the fixing plate away from the connecting plate extends beyond the base plate.

9. The safe as claimed in claim 6, wherein the base plate and the fixing plate are in an alternating fashion fixed either to the external shell or to the inner shell.

10. The safe as claimed in claim 1, wherein the inner shell defines two pouring holes, the filler passes through the pouring hole to fill the receiving space.

11. A safe comprising:
a housing comprising:
an inner shell;
an external shell surrounding the inner shell, a receiving space is defined between the inner shell and the external shell; and
a plurality of fastening brackets received in the receiving space, the fastening bracket defines a plurality of first through holes, filler can pass through the first through hole to fill the receiving space; and
a door rotationally hinged to the housing.

12. The safe as claimed in claim 11, wherein the fastening bracket comprises a base plate, the base plate defines a plurality of second through holes, the second through holes are welding points, the base plate is welded to the external shell through the second through holes.

13. The safe as claimed in claim 12, wherein the fastening bracket further comprises two connecting plates, the two connecting plates obliquely extend from two opposite edges of the base plate and extend towards each other, the first through hole are defined on the connecting plate.

14. The safe as claimed in claim 13, wherein an angel between the connecting plate and the base plate is acute.

15. The safe as claimed in claim 14, wherein the angle is being between about 20° to about 85°.

16. The safe as claimed in claim 13, wherein the fastening bracket further comprises two fixing plates, the two fixing plates extend from two edges of the two connecting plates away from the base plate and apart from each other in a co-planar fashion.

17. The safe as claimed in claim 16, wherein the two fixing plates are parallel to the base plate.

18. The safe as claimed in claim 17, wherein an edge of the fixing plate away from the connecting plate extends beyond the base plate.

19. The safe as claimed in claim 16, wherein the base plate and the fixing plate are in an alternating fixed either to the external shell or to the inner shell.

20. The safe as claimed in claim 11, wherein the inner shell defines two pouring holes, the filler passes through the pouring hole to fill the receiving space.
